(19) United States
(12) Patent Application Publication
(10) Pub. No.: US 2007/0165889 A1
(43) Pub. Date: Jul. 19, 2007

(54) Microphone apparatus having a number of silicon microphones for a hearing apparatus

(75) Inventor: Bock Swee Joshua Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 11/650,026

(22) Filed: Jan. 5, 2007

(30) Foreign Application Priority Data
Jan. 13, 2006 (DE) 10 2006 001 886.9

(51) Int. Cl. H04R 25/00

(52) U.S. Cl. 381/182; 381/396; 381/324

(57) ABSTRACT

It is intended to be able to manufacture multiple microphones for realizing highly reliable directional microphones for hearing apparatuses, and in particular for hearing devices, in a simpler manner. To this end, provision is made to develop at least two silicon microphones and at least two impedance converters connected thereto on one single chip, thereby producing an integrated circuit. In particular, twin and triplet microphones can be realized for hearing devices, which exhibit an increased reliability and a reduced sensitivity to environmental influences. Special advantages result for the one chip multiple microphones when they are designed as SMD assemblies.

### CROSS REFERENCE TO RELATED APPLICATIONS

This application claims priority of German application No. 10 2006 001 886.9 filed Jan. 13, 2006, which is incorporated by reference herein in its entirety.

### FIELD OF THE INVENTION

The present invention relates to a microphone apparatus for a hearing apparatus, in particular for a hearing device, having at least two silicon microphones and at least two impedance converters, which are each connected to one of the silicon microphones.

### BACKGROUND OF THE INVENTION

As a rule, electret microphones are currently integrated into hearing devices, headsets and suchlike. There is a need, particularly with hearing devices, to interconnect a number of integrated microphones to form directional microphones. These directional microphones assume however that the individual microphones exhibit very similar characteristics.

As electret microphones fluctuate significantly in terms of their characteristics, the production of directional microphones requires the selection of two or three sufficiently concordant microphones. This thus enables corresponding TwinMic directional microphones or TriMic directional microphones for in-the-ear hearing devices or behind-the-ear hearing devices to be manufactured. During manufacture, the selection of suitable microphones represents a labor-intensive and important design step. Even though the selected microphones then exhibit relatively similar characteristics, they still need to be adjusted to one another for use as a directional microphone. This also represents a very labor-intensive procedure. Furthermore, a certain uncertainty in respect of reliability remains during the lifespan of the product, as the individual microphones can change in different ways with the given environmental influences.

Patent application DE 103 43 292 B3 proposes a hearing device without a separate microphone housing, so that the space in the hearing device housing can be used more intensively. In order to reduce the impact-sound sensitivity of the microphones, corresponding attenuations can be provided in the hearing device shell or impact-sound insensitive silicon microphones can be used.

The article “Measurements of Silicon Microphone Arrays in Hearing Aids” by Christian Weistenhöfer and Torsten Niederdränk, Proceedings of the joint congress CFA/DAGA, Strasbourg, 22-25 Mar., 2004, pages 409 and 410 proposes a directional microphone with a number of silicon microphones. As the silicon microphones display very minimal variance among themselves from the outset, they are very suitable as directional microphones. If the microphones are integrated in a housing, the manufacturing process of the hearing device can be simplified, particularly in respect of the electrical connections. It is proposed in particular to accommodate at least four chips in a module, namely two silicon microphone chips and two impedance converter chips. Even though the installation of a directional microphone in a hearing device is simplified in this way, a relatively high manufacturing outlay nevertheless remains for the modules themselves. The individual chips must be soldered together and integrated into a corresponding housing.

### SUMMARY OF THE INVENTION

The object of the present invention thus consists in reducing the manufacturing outlay of hearing apparatuses with directional microphones.

In accordance with the invention, this object is achieved by a microphone apparatus for a hearing apparatus, in particular for a hearing device, having at least two silicon microphones and at least two impedance converters, which are connected in each instance to one of the silicon microphones, with the silicon microphones and impedance converters being developed on a single chip.

In accordance with the invention, a one chip silicon microphone arrangement, which can be automatically manufactured, is thus advantageously available. Furthermore, a special selection of the microphones for the microphone arrangement is not necessary, as the silicon microphones are only subject to minimal characteristic fluctuations.

Preferably the voltage supply inputs of the impedance converters are connected with one another and the ground terminals of the impedance converters are connected with one another. In this way, the number of terminals can be reduced compared with conventional systems.

The output terminals of the impedance converters can be positioned on one side of the chip. This allows the connection outlay for further signal processing to be reduced.

Furthermore, a power supply terminal, to which all voltage supply inputs of the impedance converters are connected, can be connected to one side of the chip and a common ground terminal, to which all ground terminals of the impedance converters are connected, is arranged on the opposite side of the chip. This generally thus also allows the wiring outlay to be reduced.

In accordance with a particularly preferred embodiment, the microphone facility according to the invention is designed as an SMD assembly. This is possible since the silicon microphones are very insensitive to vibrations. The particular advantage of the SMD assemblies lies in the fact that they can be used for an automatic mounting of printed circuit boards.

As has already been indicated, a microphone apparatus according to the invention can be integrated into a hearing device. In this way, not only dual chip microphones but also triple or multiple chip microphones can be used for behind-the-ear hearing devices and in-the-ear hearing devices.

### BRIEF DESCRIPTION OF THE DRAWINGS

The present invention is now described in more detail with reference to the appended drawings, in which:

FIG. 1 shows an inventive dual chip microphone and

FIG. 2 shows an inventive triple chip microphone.

### DETAILED DESCRIPTION OF THE INVENTION

The exemplary embodiments illustrated in more detail below represent preferred embodiments of the present invention.

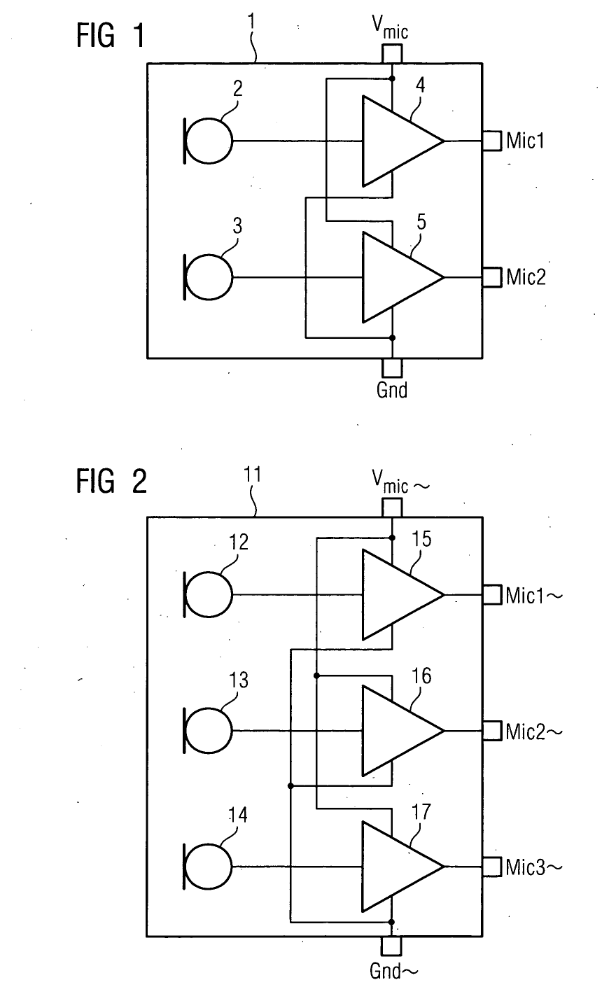

The twin microphone reproduced in FIG. 1 contains two silicon microphones 2 and 3 on one chip 1 (integrated circuit). The first microphone 2 is connected to an amplifier and/or impedance converter 4, while the second microphone 3 is connected to an amplifier and/or impedance converter 5. For power supply, each of the two impedance converters 4, 5 with its respective power supply input is connected to a power supply connection V_{mic}. On the other hand, the two impedance converters 4, 5 with their ground terminals are connected to a common ground terminal Gnd of the chip 1. Finally, the output signal of the impedance converter 4 is applied to a chip output terminal Mic1 and the output signal of the impedance converter 5 is applied to a chip output terminal Mic2.

The two silicon microphones 2 and 3 can be seen as practically identical, as they were virtually cloned on one wafer, thereby providing the ideal prerequisites for a twin microphone for a directional microphone. On account of its integration into a single chip, the long running reliability of the twin microphone can also be improved. One particular advantage lies however in the fact that the terminal outlay is reduced by means of the one chip solution, as only the four terminals V_{mic}, Gnd, Mic1 and Mic2 need to be soldered. With conventional solutions on the other hand, six terminals must be soldered, namely two power supply terminals and one output terminal for each microphone.

The twin microphone chip 1 reproduced in FIG. 1 can be designed as an SMD assembly thereby allowing it to be used in reflow soldering processes and increasing the automation level during the manufacture of hearing devices and other hearing apparatuses.

FIG. 2 shows a triplet microphone, which is based constructively on the twin microphone in FIG. 1. The silicon microphones 12, 13 and 14 are arranged on a single chip 11. The first silicon microphone 12 is connected to an impedance converter 15, the second silicon microphone 13 is connected to an impedance converter 16 and the third silicon microphone 14 is connected to an impedance converter 17. The outputs of these impedance converters 15, 16 and 17 are fed correspondingly to the chip output terminals Mic1˜, Mic2˜ and Mic3˜. The power supply of the whole chip 11 is also carried out here by way of two terminals, namely V_{mic}˜ and Gnd˜. The individual impedance converters 15, 16 and 17 are coupled to these two supply terminals. The benefit of the inventive one chip solution in respect of the terminal outlay thus becomes more evident. Only five terminals need to be soldered in the case of the chip 11 in FIG. 2, while with a comparable conventional triple microphone, nine terminals would be connected, namely two power supply terminals and one microphone output terminal for each of the three microphones.

On a single chip basis, the triplet microphone incidentally also exhibits the same advantages as the twin microphone in FIG. 1. In particular, it can also be realized as an SMD assembly.

The one chip realization results in just one common drift of the integrated microphones, which brings significantly fewer disadvantages than the different drift behaviors of the individual microphones.

1.-6. (canceled)

7. A microphone apparatus used in a hearing apparatus, comprising:
a plurality of silicon microphones;
a plurality of impedance converters each connected to one of the silicon microphones respectively; and
a single chip that comprises the silicon microphones and the impedance converters.

8. The microphone apparatus as claimed in claim 7, wherein a plurality of voltage supply inputs of the impedance converters are connected together to create a voltage supply terminal.

9. The microphone apparatus as claimed in claim 8, wherein a plurality of ground terminals of the impedance converters are connected together to create a common ground terminal.

10. The microphone apparatus as claimed in claim 9, wherein the voltage supply terminal is connected to a side of the single chip.

11. The microphone apparatus as claimed in claim 10, wherein the common ground terminal is connected to another side of the single chip.

12. The microphone apparatus as claimed in claim 11, wherein the another side of the single chip that connects the common ground terminal is opposite to the side of the single chip that connects the voltage supply terminal.

13. The microphone apparatus as claimed in claim 7, wherein a plurality of output terminals of the impedance converters are arranged on a side of the single chip.

14. The microphone apparatus as claimed in claim 7, wherein the microphone apparatus is a SMD assembly.

15. The microphone apparatus as claimed in claim 7, wherein the hearing apparatus is a hearing device.

16. A hearing device, comprising:
a plurality of silicon microphones;
a plurality of impedance converters each connected to one of the silicon microphones respectively;
a single chip that comprises the silicon microphones and the impedance converters; and
a signal processing unit connected to the single chip that processes a plurality of output signals of the impedance converters.

17. The hearing device as claimed in claim 16, wherein a plurality of voltage supply inputs of the impedance converters are connected together to create a voltage supply terminal.

18. The hearing device as claimed in claim 17, wherein a plurality of ground terminals of the impedance converters are connected together to create a common ground terminal.

19. The hearing device as claimed in claim 18, wherein the voltage supply terminal is connected to a side of the single chip.

20. The hearing device as claimed in claim 19, wherein the common ground terminal is connected to another side of the single chip.

21. The hearing device as claimed in claim 20, wherein the another side of the single chip that connects the common ground terminal is opposite to the side of the single chip that connects the voltage supply terminal.

22. The hearing device as claimed in claim 16, wherein a plurality of output terminals of the impedance converters are arranged on a side of the single chip.

23. The hearing device as claimed in claim 16, wherein the single chip is a SMD assembly.

24. A method for manufacturing a microphone apparatus used in a hearing apparatus, comprising:
providing a plurality of silicon microphones;
connecting each of the silicon microphones to one of a plurality of impedance converters respectively; and
integrating the connected silicon microphones and the impedance converters to a single chip.

25. The method as claimed in the claim 24, wherein the microphone apparatus comprising the single chip is integrated into the hearing apparatus.
